(19) United States
(12) Patent Application Publication
(10) Pub. No.: US 2015/0299966 A1
(43) Pub. Date: Oct. 22, 2015

(54) TEARING BRAKE

(71) Applicant: PFEIFER HOLDING GMBH & CO. KG, Memmingen (DE)

(72) Inventors: MARCEL FULDE, HORGEN (CH); MARKUS MULLER, DUBENDORF (CH)

(21) Appl. No.: 14/442,954

(22) PCT Filed: Apr. 17, 2013
(86) PCT No.: PCT/EP2013/057989

§ 371 Date: May 14, 2015

(30) Foreign Application Priority Data
Nov. 14, 2012 (DE) 20 2012 010 932.4

(51) Int. Cl. E01F 7/04; F16F 7/12

(52) U.S. Cl. CPC E01F 7/04; F16F 7/128

(57) ABSTRACT

The application relates to a brake element (10) for absorbing kinetic energy in a catch device, in particular for rock fall, mudslides, earth flows, landslides or tree fall. The brake element comprises a basic body (12) having a first (14) and a second (16) fastening point, wherein a tension element can be arranged at each of the first and second fastening points (14, 16) in such a way that a tensile force acting on the brake element (10) between the fastening points (14, 16) can be applied by means of the tension elements and wherein the first and the second fastening points (14, 16) have a distance (A) from one another along the tensile force. The invention is characterized in that the brake element (10) is designed in such a way that the distance (A) between the fastening points (14, 16) is increased by continuous tearing and deformation of the basic body (12) along a predetermined breaking point arrangement (18, 20) if the tensile force exceeds a predetermined amount, which predetermined breaking point arrangement (18, 20) forms a double spiral consisting of two spirals (24, 26) which extend in opposite directions and merge into one another, or forms a straight or meandering line or, in the case of cylinder-shell-shaped basic body (10), forms a helical profile in the basic body (10). The invention further relates to a catch device having such a brake element and to a method for producing such a brake element.

### TECHNICAL FIELD

The present invention relates to a brake element for absorbing kinetic energy in a catch device, in particular for rock falls, mudslides, earth flows, landslides or tree falls. The brake element comprises a basic body having a first and a second fastening point, wherein a tension element can be arranged at each of the first and second fastening points in such a way that a tensile force acting on the brake element between the fastening points can be applied by means of the tension elements and wherein the first and the second fastening points have a distance from one another along the tensile force.

The invention further relates to a catch device having such a brake element and to a method for producing such a brake element.

### PRIOR ART

Essentially brake elements for catch devices for moving masses, such as the catch device mentioned above, are known. They serve to increase the resistance of such catch devices to sudden, violent impacts by moving masses. In particular such a brake element essentially ensures that an element subject to tensile load, such as a retaining rope or anchor, for example, does not tear when subject to an intense impact by a body. The brake element continuously dissipates the kinetic energy transferred to the catch device by the impact, various systems being known for this in the prior art. A form of such brake elements is designed to convert kinetic energy into deformation energy and thereby to achieve continuous dissipation of the energy. Examples of this are known from EP 1 156 158 B1 and EP 1 302 595 A1. In these systems a retaining/guy rope is led through a brake element, which extends substantially orthogonally to the adjacent course of the retaining rope and is compressed or torn when a predetermined amount of tensile force on the retaining rope is exceeded. One of the disadvantages of these devices is that they have a relatively large extension. In both cases it is necessary for the brake device to be half the length of a desired brake path, wherein the brake path according to the present invention corresponds to a length of rope, which can be let out via the brake element relative to an unloaded state of the retaining rope, i.e. by which the rope can give. Moreover, these devices require that the rope is inserted into the brake element and led through the brake element through relatively small radii of curvature. This creates sharp deflections in the rope, so that it can be damaged or overloaded when it is loaded.

WO 2009/137951 A1 discloses a shock absorbing device for rope constructions, for example for rock fall installations, in which preferably multiple straps or ropes are stretched over a deflection mechanism under heavy loading in order to absorb some of the energy of an impact. There are also devices, in which a substantially orthogonal rolled profile is deformed under heavy loading into a substantially linear profile, if a heavy load acts on the profile.

Both of these devices share the problem that inevitable soiling of the devices causes friction, which greatly impairs the deformation capacity and above all the predictability of deformation of the straps or ropes or of the rolled section. Both these devices must therefore be constantly cleaned to ensure that they function properly.

A brake element is known from EP 1 469 130 A1, in which a helical spiral of plastically deformable material is used, which deforms under heavy tensile loading, thereby converting the kinetic energy transferred from the mass to the catch device into deformation energy. However, a disadvantage of this device is that it takes up a relatively large amount of space and is not very universally applicable. The helical spiral cannot be satisfactorily adapted to different amounts of energy input, since energy dissipation only takes place by means of bending up and torsion. Moreover, it is not easy to see on the helical spiral itself to what extent it is already loaded and is still capable of taking further loadings. In other words, the helical spiral must be replaced, even if it's load capacity is not exhausted, in order to ensure that it continues to absorb sufficient kinetic energy, in the event of the catch device being loaded again. It is therefore not possible to reliably reuse the helical spiral.

### OUTLINE OF THE INVENTION

Given the background of the prior art, the object of the present invention is therefore to provide a brake element in the above technical fields, that is simultaneously maintenance-free, space-saving and rope-friendly and also offers the possibility that it can continue to be used reliably following non-exhaustive loading. A further object of the present invention is to provide a brake element that can be simply adapted to different levels of kinetic energy to be absorbed by the brake element.

This object is achieved by a brake element according to Claim 1. Further advantageous embodiments of the brake element may be derived from the subclaims.

The brake element according to the invention for absorbing kinetic energy in a catch device, particularly for rock falls, mudslides, earth flows, landslides or tree falls, comprises a basic body having a first and a second fastening point, wherein a tension element can be arranged at each of the first and second fastening points in such a way that a tensile force acting on the brake element between the fastening points can be applied by means of the tension elements. Therein, the first and second fastening points have a distance from one another along the tensile force. The brake element according to the invention is designed in such a way that the distance between the fastening points is increased by continuous tearing and deformation of the basic body along a tearing line, if the tensile force exceeds a predetermined amount. In other words, the fastening points with the tension elements attached to them move away from each other due to tearing and deformation of the basic body along a predetermined tearing line or shape, wherein the tension elements can yield to the tensile force over the increased distance between the fastening points, so preventing overloading of the tension elements. In this way the forces in the ropes and in the entire protection system can be limited to the necessary values.

A catch device in the sense of the present invention can be in particular a safety net, which is usually used for rock falls, mudslides etc. However, in principle such a safety net can also be provided for other moving masses and masses to be decelerated, for example as a safety net on construction sites, at the side of the road or on cableways, cranes or elevators. The first and second fastening points can in particular be formed by an eyelet, multiple eyelets, one or more fastening hooks or one or more similar fastening elements or a preliminary setup for one or more such fastening elements, via which the basic body can be coupled with one tension element respectively, so that a tensile force acting on a first tension element can be transferred via the basic body to the second tension element. It is also possible that, instead of a fastening device, a location is merely determined, at which a tension element can be or is attached. For example, the tension elements can be in each case parts of a retaining rope for a safety net, which is subjected to a tensile force when the safety net is loaded. This tensile force is then also transferred to the basic body of the brake element.

The continuous tearing and deformation of the basic body along the predetermined tearing line, according to the invention, means that every increase in the distance between the two fastening points is associated with further tearing and further deformation of the basic body. In the present case, this continuous tearing and deformation also comprises a stepwise tearing and deformation, that is to say the continuous tearing and deformation can also take place in multiple discrete steps, one following on from the other. However, continuous tearing and deformation is to be differentiated from one-off tearing of a predetermined breaking point and subsequent deformation alone, without further tearing taking place.

The tearing line in the basic body, along which the brake element tears and deforms, is advantageously predetermined by a predetermined breaking point arrangement. Such a predetermined breaking point arrangement can in particular comprise a web of one or more material bridges of reduced cross-section, one or more perforations, one or more notches or one or more blind drilled holes. It is also possible for the predetermined breaking point arrangement to be formed by one or more welding points spaced at a distance from each other. The predetermined breaking point arrangement serves to define the predetermined tearing line, along which the basic body tears when a predetermined tensile force is exceeded, and in this way to form a determined system in terms of the threshold value for the start of tearing and deformation and also in terms of the shape along which the basic body tears. Thus this also determines the brake path that the brake element can provide for the tension elements attached to it.

When the material bridges of the predetermined breaking point arrangement tear, the kinetic energy that is to be dissipated by the brake element is already converted to a substantial extent. Moreover, the deformation of the brake element dissipates additional energy, so that the brake element according to the invention is particularly efficient in dissipating kinetic energy, without requiring a lot of space or a lot of material to do so. The said predetermined breaking point arrangement can preferably have perforations, which are either only superficial or penetrate through the thickness. In other words, the perforations can either completely penetrate the basic body or only remove part of the surface from the region of the desired predetermined breaking points, thereby creating a material bridge of reduced cross-section.

In a preferred embodiment, the predetermined breaking point arrangement is curvilinear. With a curvilinear predetermined breaking point arrangement, it is possible to optimally utilize the material of the basic body for tearing and deformation of the brake element. A curvilinear predetermined breaking point arrangement also results in the basic body, which will tear along the predetermined breaking point arrangement, initially, i.e. before deformation, having a curvilinear shape. This curvilinear basic body section can then still stretch when it is loaded, to allow a maximum distance between the two fastening points of the basic body, which requires further deformation energy and can thus dissipate additional kinetic energy.

The tearing line, in particular therefore the predetermined breaking point arrangement, preferably forms a double spiral in the basic body, at one end of which the first fastening point is arranged and at the other end of which the second fastening point is arranged, wherein both fastening points are arranged in an outer region of the spiral. The spiral therefore unfurls due to continuous tearing and deformation of the basic body, if the tensile force exceeds a predetermined value. The spiral shape of the tearing line, in particular of the predetermined breaking point arrangement, is thereby so designed that the predetermined tearing path, predetermined by the tearing line, in particular the predetermined breaking point arrangement, starts at the outside, i.e. starting from the fastening points at the edge. For this purpose the tearing line has the form of a double spiral or a double helix.

In association with this preferred embodiment, a (double) spiral is particularly preferably understood to be a flat (double) spiral, i.e. a substantially two-dimensional (double) spiral, the expanse of which in a two-dimensional plane is substantially (at least by a factor of 10) greater than in the direction running perpendicular to this. However, it is essentially also possible that the (double) spiral lies in a curved plane. In another embodiment, the (double) spiral can also be designed as a helix, i.e. the tearing line, in particular the predetermined breaking point arrangement, can extend over the surface of a cylinder or cone so that this can tear or be deformed. The cylindrical or conical basic body must not only deform but also tear in order to increase a distance between two fastening points.

In this way it is possible to provide a compact brake element with a compact basic body, which, with a (double) spiral-shaped tearing line, in particular a predetermined breaking point arrangement, results in the basic body unfurling along the spiral shape, namely deforming, in particular tearing and deforming, when a predetermined amount of tensile force is exceeded. By arranging the first and second fastening point at each end of the (double) spiral respectively, it is possible to use the entire length of the (double) spiral, when unfurled, to dampen a tensile force on the tension element, in other words to serve as a brake path. Moreover, it is also possible that the (double) spiral is only partially deformed, preferably torn and deformed, that is to say is stretched, wherein the brake element can be designed such that the basic body initially deforms, preferably tears and deforms, in the region of the fastening points, causing the (double) spiral to unfurl.

The double spiral consists of two spirals which extend in opposite directions and merge into one another. This allows the basic body to continuously deform, preferably tear and deform, particularly efficiently; that means that a particularly compact construction of the brake element is possible, while at the same time a long brake path can be produced. Thus the simultaneous unfurling of the two parts of the double spiral from the outer ends respectively results in rotation of the two portions, and hence of the double spiral, in the same direction.

The double spiral is preferred, because in this case no rotational movements take place between the brake element and the tension elements, which would require countermeasures in a single spiral.

Additionally the tearing line can also be a straight, linear perforation, preferably arranged centrally, in a steel strip, so that it can be torn open and deformed like to a zipper. Another alternative is a disc of sheet metal as a basic body with meandering perforation, that is to say tearing line. In particular, in the embodiments explained above, tearing of the tearing line, therefore in particular of the material bridges, can take place by shearing. For example, tearing can take place by means of a wedge severing the material bridges, said wedge being connected with one of the fastening points of the brake element.

With a cylinder-shell-shaped basic body, a helical configuration of the tearing line over the surface of the cylinder is also possible. Due to the helical tearing line, in the extended state the cylinder-shell-shaped basic body becomes a substantially linear extended strip of the material of the basic body.

The basic body of the brake element is advantageously discoid. The diameter and thickness of said disc can vary arbitrarily in keeping with the requirements of the protection system and be adapted to the same. The effect of a thicker disc is that more energy is necessary to deform the basic body, wherein the energy required for tearing alone can be set by adapting the predetermined breaking point arrangement and can remain largely unaffected by the thickness of the disc. Thus the brake element can be adapted relatively easily to different amounts of energy that are expected and need to be absorbed by setting the energy necessary for tearing, without having to change the thickness of the basic body.

The diameter of the basic body affects the length of the brake element in its completely extended state, wherein this length correlates with the width of the stretched basic body. For the same length, a greater width of the stretched basic body requires a greater disc diameter.

In this case, a discoid or plate-type shape is understood to mean a shape wherein the two-dimensional extensions are substantially greater than its thickness perpendicular to the same. Therefore a discoid or plate-type basic body is a substantially flat, two-dimensional element, the thickness of which perpendicular to the flat expanse is smaller than said flat expanse by at least a factor of 10. The said flat element can be curved but is preferably non-curved. The said discoid basic body is preferably substantially circular or oval. A circular or oval basic body allows a particularly efficient configuration of a tearing line, in particular a predetermined breaking point arrangement in the form of a double spiral. This configuration of a tearing line or predetermined breaking point arrangement has proven to be particularly advantageous. Here it is necessary to consider that possible eyelets or other configurations of the basic body as fastening point must not prejudice the circular or oval shape of the basic body, i.e. a basic body, external contour only deviates from a circular or oval shape due to these fastening points but should nevertheless be regarded as circular or oval-shaped.

In a preferred embodiment, the basic body comprises multiple discs arranged on top of each other and parallel to each other. These discs can then be joined to each other in a sandwich construction or lie parallel to and separate from each other. Advantageously, the individual discs of the basic body are joined to each other in the region of the fastening points, so that a tensile force acting between the fastening points is uniformly transferred to the multiple discs arranged on top of each other and parallel to each other and produces uniform tearing and deformation of the multiple portions of the basic body.

The basic body is advantageously made from metal, in particular from steel, or from a composite material. Such materials are easy to adjust in terms of their specific weakening as a predetermined breaking point arrangement and their plastic deformability, so that the tearability and deformability of the basic body can the selectively influenced by the choice of material. In this connection, the basic bodies used in a sandwich construction can also consist of different materials, comprise layers of different thicknesses or have undergone different treatment. It is further preferred to form the brake element as a casting. This allows the brake element to be produced very efficiently.

The brake element preferably has a marking indicating the residual useful length of the brake element. Such a marking can in particular be a graphic element, for example imprints or notches, which can display the degree to which the brake element has so far been utilized. Thus it is particularly easy to allow the element to be reutilized by renewed loading, if the tearing line has not been used up, without uncertainty about the residual load capacity of the brake element. Hence the brake element can be used multiple times without risks to safety.

In a preferred embodiment, the brake element has a deformation sensor to detect tearing and/or deformation of the basic body. Such a deformation sensor can, for example, comprise a sensor that detects tearing of the predetermined breaking point arrangement at a particular position, for example at the position of a marking. A sensor of this type is an electronic element, which, for example, allows electronic processing of the information that the brake element has been deformed over a specified dimension.

Particularly preferably the brake element further has a transmitter to transmit a tearing and/or deformation of the basic body detected by the deformation sensor to a receiver. This can, for example issue an alarm signal to authorities or maintenance services, who can then check and replace the brake element. For example, an avalanche warning can be generated in this way.

Advantageously the predetermined breaking point arrangement in the form of a double spiral has a center, at which the two opposed spirals merge. Thus this center is a place at which the two spirals are connected to each other and which is normally arranged in the center of the brake element, to enable the two spirals forming the double spiral to be arranged symmetrically. This center is defined by two predetermined breaking points in the shape of oblong holes, in that these slot-shaped predetermined breaking points surround the center in areas. These slot-shaped predetermined breaking points can preferably be two slot-shaped perforations, notches or through holes, which are formed, for example, like the “Taji” or “Hotu” Yin and Yang symbol and disposed around the center of the double spiral. By means of the predetermined breaking points, which are disposed around the center of the brake element, the brake element can unfurl in the defined way to its full extent and withstand high loadings. The preferred configuration of the predetermined breaking points situated in the center and therefore the last to be affected in the unfurling direction of the brake element facilitates clearly defined extension of the basic body. It prevents tearing of the basic body in the area immediately around its center, which could cause weakening of the basic body in the extended state. The preferred configuration of the predetermined breaking points therefore helps to make the brake element particularly resistant to heavy loadings.

With the brake element according to the invention it is particularly easy to adjust the brake path or braking distance and energy absorption capacity to the specific requirements. For example, this can be achieved via the degree of weakening of the basic body along the predetermined breaking point arrangement, via the size of the basic body, via the choice of materials for the basic body and also via the pattern of the tearing line, in particular the predetermined breaking point arrangement.

A catch device according to the invention, in particular for rock falls, mudslides, earth flows, landslides or tree falls, comprising a brake element according to the above description. By means of this brake element, it is possible to protect the catch device against particularly violent impacts, so that the catch device according to the invention functions particularly reliably, even when subjected to intense impacts.

A further object of the present invention is thereby achieved, namely to provide a catch device, which is improved against heavy impacts that would exceed the load capacity of the retaining rope used, and is at the same time space-saving and universally applicable.

The brake element is preferably arranged in such a way that the first fastening point is operatively connected with a barrier, in particular a safety net, and the second fastening point is operatively connected with an anchor of the catch device. In this way the brake element is arranged along the tensile force between the barrier and its anchor, so that it can react particularly efficiently to the kinetic energy arriving at the barrier.

It is possible to use multiple brake elements in parallel in a catch device. In this case the brake elements can be coordinated with each other in terms of their resistance and their braking length, i.e. have the same or deliberately different values.

The invention further relates to a method for producing a brake element according to the above description. In this method a plate-type basic body is provided with a predetermined breaking point arrangement using non-machining techniques, in particular by laser cutting or water jet cutting. In an alternative method according to the invention for producing such a brake element a plate-type basic body is provided with a predetermined breaking point arrangement using machining techniques, in particular sawing or drilling.

Insofar as the basic body is preferably a singular disc, it is possible to largely finish the brake element using the method according to the invention. Hence the brake element does not require any further finishing steps, inasmuch as the fastening points are already provided on the basic body.

Another alternative method for producing a brake element involves creating material bridges along a tearing line formed as a groove, wherein the said material bridges are created by means of individual welds or welding points along the groove. These welding points are then formed in such a way that they tear along the groove when subjected to a defined amount of loading, thereby allowing the basic body to deform.

The brake element described above achieves the object of the invention outlined above and overcomes the disadvantages of the prior art. In particular, it is possible to provide a brake element that largely prevents damage to tension ropes, at the same time being of a particularly compact design and allowing reliable assessment of the residual load capacity of the brake element, even if the brake element has already been subjected to a first loading. Since its mode of operation is frictionless and without moving parts, the brake element is completely unaffected by dirt.

Further advantageous features and effects of the invention follow from the following description of the Figures and the totality of the claims.

### BRIEF DESCRIPTION OF THE FIGURES

FIG. 1 shows a brake element in a preferred first embodiment.

FIG. 2 shows a brake element in a preferred second embodiment.

FIG. 3 shows a brake element in a preferred third embodiment.

FIG. 4 shows a brake element in a preferred fourth embodiment.

### WAYS OF IMPLEMENTING THE INVENTION

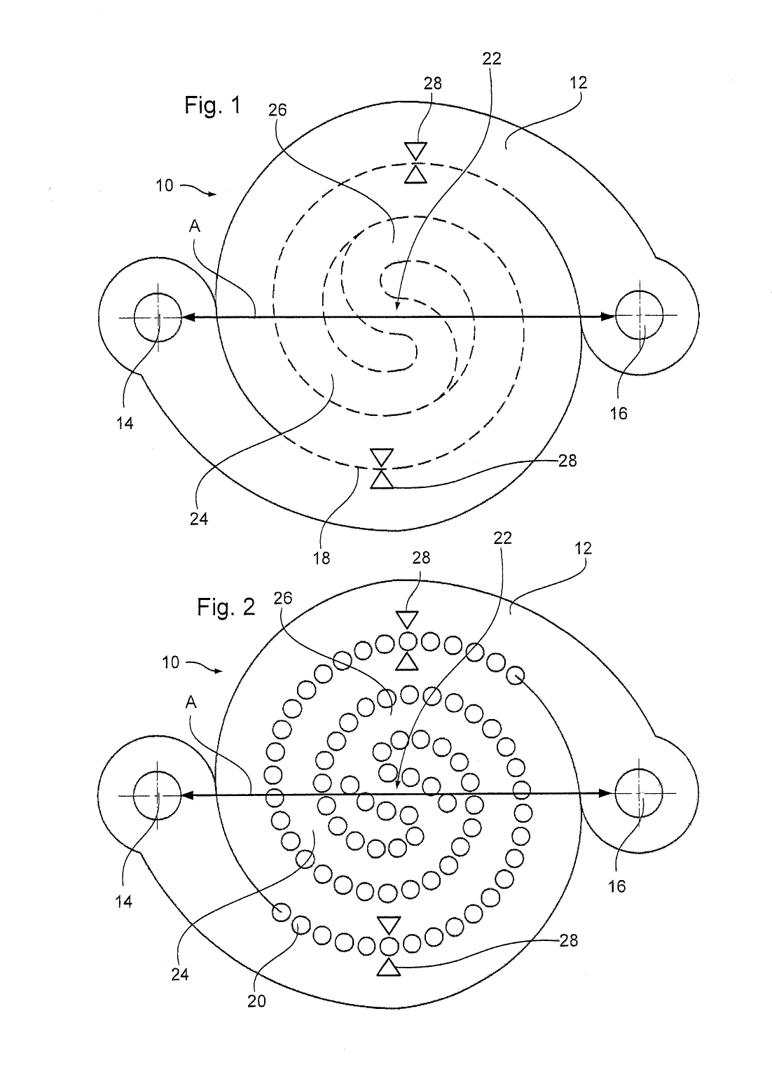

FIG. 1 shows a brake element 10 according to a first preferred embodiment. The brake element 10 has a discoid basic body 12, which is substantially circular and has a first fastening point 14 and a second fastening point 16 on opposite sides. In the preferred embodiment, these fastening points 14, 16 are formed by eyelets, which are designed to receive a tension rope, a tension rod or a similar tension element. For example, a tension element can be attached to the fastening points 14, 16 by means of a shackle or a similar fixing device.

The fastening points 14, 16 have a distance A from each other, which is measured along the direct and therefore shortest path between the two associated fastening points 14, 16. This distance A also runs along a tensile force, which would act between the fastening points 14, 16, if the tension elements attached to the fastening points 14, 16 were subjected to tensile loading against each other. In this case, the effect of the tensile force is that the fastening points 14, 16 want to move away from each other but are prevented from doing so by the strength of the material of the basic body 12.

The basic body 12 has a predetermined breaking point arrangement 18, which, in the embodiment shown in FIG. 1, is formed by a web of material bridges of reduced cross-section in the form of multiple notches. In the embodiment shown in FIG. 1, this predetermined breaking point arrangement 18 is configured in the form of a spiral 22, wherein the spiral 22 of the embodiment shown in FIG. 1 forms a double spiral consisting of a first spiral 24 and a second spiral 26. The spiral 22 according to this preferred embodiment is configured so that, when it is loaded, the basic body starts to tear in the region of the fastening points 14, 16 and this tearing continues inwards while deforming the basic body 12.

Due to the predetermined breaking point arrangement 18, the basic body 12 tears in a spiral shape when a predetermined amount of tensile force is exceeded between the fastening points 14, 16, namely along the predetermined breaking point arrangement 18. At the same time the material of the basic body 12 deforms, in that the spiral 22 defined by the predetermined breaking point arrangement 18 unfurls, that is to say the material stretches along the tensile force under the effects of tearing and deformation of the basic body 12. In this way the distance A between the fastening points 14, 16 increases by means of continuous tearing and deformation of the basic body 12, as soon as a tensile force in excess of a predetermined amount is applied to the fastening points 14, 16.

With sustained tensile force, the basic body 12 unfurls by tearing and deforming the basic body 12 until the spiral 22 is completely unfurled and the basic body 12 is completely stretched. In this condition the brake element 10 takes up its maximum extension. The brake element 10 is therefore designed to allow the tension elements attached to the brake element 10 to give, wherein the braking length or brake path, that is to say the length or the path over which the distance between the fastening elements 14, 16 can increase on application of a corresponding tensile force, is defined by the difference between the overall length of the spiral in the completely unfurled state and the distance A between the fastening points 14, 16 in the normal state shown in FIG. 1. This braking length is very long compared with the expanses of the basic body 12 in the normal state. Hence a compact construction of a brake element is possible, which simultaneously allows absorption of a large amount of kinetic energy acting on a catch device in which the brake element 10 is installed.

Markings 28 are provided for partial tearing and deformation of the basic body 12, said markings being shown by way of an example in FIG. 1 as opposing triangles on either side of the predetermined breaking point arrangement 18. Insomuch as the basic body 12 is already partially torn and deformed when the brake element 10 is utilized, the markings 28 indicate how much kinetic energy the brake element 10 can convert into deformation energy in the manner described when the brake element is next loaded. The markings 28 are only shown by way of an example in FIG. 1 and can be provided at any other location along the predetermined breaking point arrangement. It is also possible to provide multiple markings to allow a more exact indication of the kinetic energy already converted by the brake element 10. For example, contact sensors, which can be used as deformation sensors, can be arranged at the position of the marking 28 or at other or multiple positions. By means of these electronic elements it is also possible to check the state of tearing or deformation of the brake element remotely.

FIG. 2 shows another embodiment of the brake element 10, wherein most of the elements of the brake element 10 correspond to the embodiment shown in FIG. 1. Elements that are the same are designated by the same reference numerals and not included in the following description.

Unlike the embodiment shown in FIG. 1, the predetermined breaking point arrangement 20 in the embodiment shown in FIG. 2 is formed by a perforation formed from multiple blind drilled holes. Alternatively, however, the blind drilled holes of the predetermined breaking point arrangement 20 may also be through holes. In this case, the predetermined breaking point arrangement 20 is formed by through holes disposed along the desired tearing line of the predetermined breaking point arrangement.

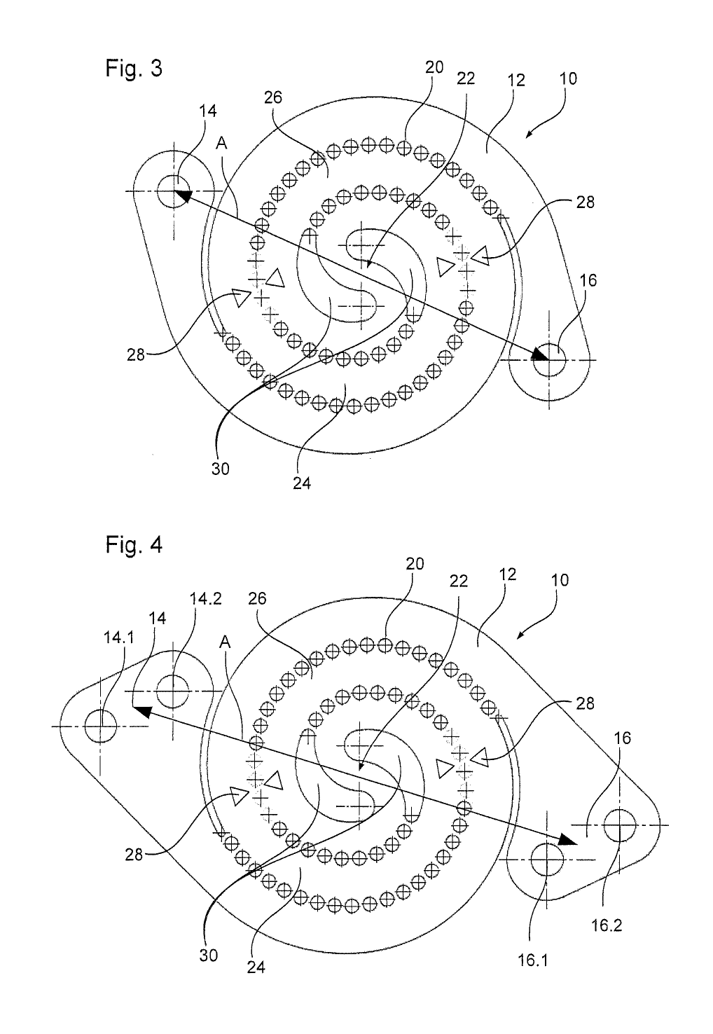

Unlike the embodiment according to FIG. 2, the brake element 10 according to FIG. 3 comprises two slot-shaped predetermined breaking points 30, which surround a center of the spiral 22. These predetermined breaking points 30 facilitate a defined unfurling of the basic body 12 in the region of the center, thereby increasing the resistance of the brake element 10 to particularly high loadings. In other respects, the embodiment according to FIG. 3 is the same as that in FIG. 2.

The embodiment shown in FIG. 4 varies from that of FIG. 3 in terms of the configuration of the first and second fastening points 14, 16. While the embodiments according to FIGS. 1-3 have a single eyelet as a first fastening point 14 and second fastening point 16 respectively, the embodiment according to FIG. 4 uses two eyelets 14.1, 14.2 as first fastening point 14 and two eyelets 16.1, 16.2 as second fastening point 16. This allows greater loads to be transferred to the brake element 10 than in the case of a single eyelet as in FIGS. 1-3. In other respects, the embodiment according to FIG. 4 is the same as that in FIG. 3.

Both the notches of the predetermined breaking point arrangement 18 according to FIG. 1 and the blind drilled holes or perforations of the predetermined breaking point arrangement 20 according to FIGS. 2, 3 and 4 result in targeted weakening of the basic body 12 along the course of these elements. This causes the basic body 12 to tear along this tearing line predetermined by the predetermined breaking point arrangement 18, 20, which allows particularly efficient use of the material of the basic body 12, in that, for example, the basic body 12 unfurls in a predetermined spiral shape, thereby providing a relatively long braking length of the brake element at the same time as a compact normal state.

However, it is essentially also possible for the basic body 12 to have a different shape from that shown in FIGS. 1-4 and the predetermined breaking point arrangement 18, 20 may also have a shape other than a spiral. In particular it is possible for the basic body 12 to have a rectangular shape, which can tear, for example, by deliberately inserting weaker material or by geometric weakening along a predetermined tearing line, in order to thereby increase the distance between the fastening points due to continuous tearing and deformation of the basic body, if a correspondingly high tensile force acts on the fastening points 14, 16.

1. The brake element (10) for absorbing kinetic energy in a catch device, in particular for rock falls, mudslides, earth flows, landslides or tree falls, comprising
a basic body (12) having a first (14) and a second fastening point (16), wherein a tension element can be arranged at each of the first and second fastening points (14, 16) in such a way that a tensile force acting on the brake element (10) between the fastening points (14, 16) can be applied by means of the tension elements and
wherein the first and the second fastening points (14, 16) have a distance (A) from one another along the tensile force,
characterized in that
the brake element (10) is designed in such a way that the distance (A) between the fastening points (14, 16) is increased by continuous tearing and deformation of the basic body (12) along a tearing line, if the tensile force exceeds a predetermined amount, wherein said tearing line is predetermined in the basic body (10) by a predetermined breaking point arrangement (18, 20).

2. The brake element (10) according to claim 1, wherein the breaking point arrangement (18, 20) comprises a web of one or more material bridges of reduced cross-section, which are optionally formed by weld points.

3. The brake element (10) according to claim 1, wherein the breaking point arrangement (20) comprises one or more perforations, notches and/or blind drilled holes.

4. The brake element (10) according to claim 1, wherein the predetermined breaking point arrangement (18, 20) is curvilinear.

5. The brake element (10) according to claim 1, wherein the tearing line forms a double spiral (22) consisting of two spirals (24, 26) which extend in opposite directions and merge into one another or forms a straight or meandering line or, in the case of a cylinder-shell-shaped basic body (10), forms a helical profile in the basic body (10).

6. The brake element (10) according to claim 1, wherein the first fastening point (14) is arranged at a first end of the tearing line formed as a double spiral (22) and the second fastening point (16) is arranged at a second end of the tearing line formed as a double spiral (22).

7. The brake element (10) according to claim 6, wherein the tearing line, in particular the double spiral (22) unfurls due to continuous tearing and deformation of the basic body (12), if the tensile force exceeds a predetermined amount.

8. The brake element (10) according to claim 1, wherein the basic body (12) is discoid, in particular comprises multiple discs arranged on top of each other and parallel to each other.

9. The brake element (10) according to claim 1, wherein the basic body (12) is made from metal, in particular from steel, or is made from a composite material and/or is formed as a casting.

10. The brake element (10) according to claim 1, having a marking (28), which indicates a residual useful length of the brake element (10), and/or a deformation sensor, which is able to detect a tearing and/or deformation of the basic body, wherein the brake element preferably has a transmitter to transmit a tearing and/or deformation of the basic body detected by the deformation sensor to a receiver.

11. The brake element (10) according to claim 6, wherein the double spiral (22) has a center, at which the two opposed spirals (24, 26) merge, wherein the center is defined by two slot-shaped predetermined breaking points.

12. A catch device, in particular for rock falls, mudslides, earth flows, landslides or tree falls, comprising a brake element (10) according to claim 1.

13. A catch device according to claim 12, in which the brake element (10) is arranged in such a way that the first fastening point (14) is operatively connected with a barrier, in particular a safety net, and the second fastening point (16) is operatively connected with an anchor of the catch device.

14. A method for producing a brake element (10) according to claim 1, wherein a plate-type or cylinder-shell-shaped basic body (12) is provided with a defined tearing line.

15. The method according to claim 14, wherein the predetermined breaking point arrangement is created by non-machining techniques, in particular laser beam cutting or water jet cutting, or by machining, in particular sawing or drilling, or by welding of individual welding points spaced at a distance from each other.
